(19) United States
(12) Patent Application Publication
(10) Pub. No.: US 2015/0308368 A1
(43) Pub. Date: Oct. 29, 2015

(54) ACTIVE ENGINE FUEL PRESSURE PULSATION CANCELLATION TECHNIQUES

(71) Applicants: Russell J. Wakeman, Canton, MI (US); Adam Fleischman, White Lake, MI (US)

(72) Inventors: Russell J. Wakeman, Canton, MI (US); Adam Fleischman, White Lake, MI (US)

(21) Appl. No.: 14/263,249

(22) Filed: Apr. 28, 2014

(51) Int. Cl. F02D 41/38

(52) U.S. Cl. CPC F02D 41/3863; F02D 2041/389

(57) ABSTRACT

An active fuel pressure pulsation cancellation technique includes receiving, at a controller of an engine having a camshaft-driven fuel pump, an unfiltered fuel pressure signal indicative of a measured pressure of fuel in a fuel rail. The technique includes detecting, at the controller, fuel pressure pulsations in the fuel rail based on the unfiltered fuel pressure signal. The technique includes generating, at the controller, a cancellation signal based on an opposite polarity of the fuel pressure pulsations. The technique also includes controlling, by the controller, an actuator associated with the fuel rail using the cancellation signal to cause the actuator to generate liquid-borne cancellation pulsations that cancel the fuel pressure pulsations in the fuel rail.

### FIELD

The present disclosure relates generally to internal combustion engines and, more particularly, to active engine fuel pressure pulsation cancellation techniques.

### BACKGROUND

Engines combust a mixture of air and fuel to rotatably turn a crankshaft to generate drive torque. A fuel system of the engine includes a fuel rail that houses the fuel, a fuel pump that pumps fuel into the fuel rail, and fuel injectors that inject the fuel from the fuel rail into the engine. Examples of the fuel include gasoline and diesel, and example configurations of the fuel injectors are direct injection (DI) and port fuel injection (PFI). A controller of the engine controls the fuel injectors to inject a desired amount of fuel into the engine, e.g., based on an engine torque request. A pressure of the fuel in the fuel rail affects the amount of fuel injected into the engine.

Fuel pressure sensors are implemented to measure the pressure of the fuel in the fuel rail. Fuel pressure pulsations occur due to the pumping of the fuel into the fuel rail by the fuel pump and due to the injection of fuel from the fuel rail into the engine by the fuel injectors. These fuel pressure pulsations are greater in high fuel pressure systems, such as DI engines. These high fuel pressure systems typically utilize fuel pumps that are driven by a camshaft of the engine, which further augments the fuel pressure pulsations. The camshaft is operable to control intake/exhaust valves of the engine, and is driven by the crankshaft.

Referring now to FIG. 1, an example plot of fuel pressure pulsations in a DI engine having a camshaft-driven fuel pump is illustrated. A fuel pump pressure waveform 10 is indicative of a pressure of fuel in a pump chamber of the fuel pump corresponding to pump events and is plotted with respect to a crankshaft position axis 12 (in units of degrees; also known as crankshaft angle degrees or CAD) and a low pressure axis 14 (in units of bar). Fuel injection waveforms 16, 18, 20, and 22 are indicative of fuel injection events corresponding four different fuel injectors, respectively, and are plotted with respect to the crankshaft position axis 12 and a fuel mass flow rate axis 24 (in kilograms per second).

A fuel pressure waveform or signal 26 is indicative of a pressure of the fuel in a fuel rail and is plotted with respect to the crankshaft position axis 12 and a high pressure axis 28 (in units of bar). As previously discussed, the fuel pressure in the fuel rail is typically much higher than the fuel pressure in the fuel pump. Each fuel injection event causes a decrease 30 in the fuel rail pressure followed by an increase 32 in the fuel rail pressure due to a subsequent pump event. Following this increase 32, the pump event causes fuel pressure pulsations 34 in the fuel rail, which are seen in the fuel pressure signal 26. These fuel pressure pulsations could also reverberate in the fuel rail, e.g., due to acoustic effects, causing additional fuel pressure pulsations.

Conventional engine fuel systems control the injection timing or pulse-width of fuel injectors with a presumption that the fuel mass flow rate during the injection period is known and constant. This presumption is only true when the pressure drop across the injector from its supply (the fuel rail) to its discharge orifice is known and constant. In reality, the pressure drop across the injector varies quite widely both because of the variation in the discharge pressure within the engine (fuel injection from the fuel rail) and because of the variation in the accuracy of the pressure control of the supply of fuel (fuel pumping into the fuel rail). Because fuel injection is typically controlled based on the fuel pressure signal 26, these fuel pressure pulsations 34 negatively affect fuel injection performance.

More particularly, conventional engine fuel systems typically average or smooth the fuel pressure signal. These fuel pressure pulsations, therefore, are incorporated into the averaged or smoothed fuel pressure signal, thereby creating an inaccurate fuel pressure signal. When fuel injection is then controlled based on this inaccurate fuel pressure signal, inaccurate fuel injection and/or component damage could occur. For example, the inaccurate fuel injection could cause cylinder indicative mean effective pressure (IMEP) imbalance and/or cylinder air/fuel ratio variability. Calibration mapping and feedback algorithms could be difficult to implement because the injectors will not have a uniform delivery rate at varying operating points.

Thus, while conventional engine fuel systems work for their intended purpose, there remains a need for improvement in the relevant art.

### SUMMARY

In one aspect, an engine system is provided in accordance with the teachings of the present disclosure. In an exemplary implementation, the engine system includes an engine, a fuel system, a fuel pressure sensor, an actuator, and a controller. The engine is configured to rotatably turn a crankshaft to generate drive torque, the crankshaft also being operable to drive a camshaft of the engine. The fuel system includes: a fuel rail configured to house the fuel, a fuel pump driven by the camshaft and configured to pump the fuel into the fuel rail, and fuel injectors configured to inject the fuel from the fuel rail into the engine. The fuel pressure sensor is configured to generate an unfiltered fuel pressure signal indicative of a measured pressure of the fuel in the fuel rail. The actuator is configured to generate liquid-borne cancellation pulsations in the fuel rail in response to a cancellation signal. The controller is configured to: receive the unfiltered fuel pressure signal, detect fuel pressure pulsations in the fuel rail based on the unfiltered fuel pressure signal, generate the cancellation signal having an opposite polarity of the fuel pressure pulsations, and control the actuator utilizing the cancellation signal to generate the liquid-borne cancellation pulsations to cancel the fuel pressure pulsations in the fuel rail.

In another aspect, a method is provided in accordance with the teachings of the present disclosure. In an exemplary implementation, the method includes receiving, at a controller of an engine, the controller having one or more processors, an unfiltered fuel pressure signal indicative of a measured pressure of fuel in a fuel rail of the engine, wherein the engine is configured to rotatably turn a crankshaft to generate drive torque, the crankshaft also being operable to drive a camshaft of the engine, wherein the camshaft drives a fuel pump configured to pump the fuel into the fuel rail, and wherein fuel injectors are configured to inject the fuel from the fuel rail into the engine. The method includes detecting, at the controller, fuel pressure pulsations in the fuel rail based on the unfiltered fuel pressure signal. The method includes generating, at the controller, a cancellation signal having an opposite polarity of the fuel pressure pulsations. The method also includes controlling, by the controller, utilizing the cancellation signal, an actuator associated with the fuel rail, wherein the cancellation signal causes the actuator to generate liquid-borne cancellation pulsations that cancel the fuel pressure pulsations in the fuel rail.

In some implementations, the unfiltered fuel rail pressure signal corresponds to a currently firing or previously fired cylinder of the engine, and the cancellation signal is further based on a fuel injection timing or pulse-width for a next firing cylinder of the engine. In some implementations, the controller is further configured to phase-shift the cancellation signal based on a distance between (i) the actuator and (ii) one of the fuel injectors corresponding to the next firing cylinder of the engine. In some implementations, the controller is further configured to: receive a crankshaft position signal indicative of a rotational position of the crankshaft; and determine the next firing cylinder of the engine based on the crankshaft position signal.

In some implementations, the actuator is a piezoelectric actuator having at least a portion disposed within the fuel in the fuel rail proximate the fuel injectors. In some implementations, the actuator is a piezoelectric actuator attached to a diaphragm disposed within the fuel in the fuel rail.

In some implementations, the engine system further comprises a fuel line between the fuel pump to the fuel rail, and an accumulator housing fuel selectively diverted from the fuel line. In these implementations, the actuator is an accumulator valve configured to selectively divert the fuel from the fuel line into the accumulator.

In some implementations, the actuator comprises a stack of piezoelectric actuators, an input piston, a hydraulic fluid line, and an output piston disposed within the fuel rail. The output piston is configured to generate the liquid-borne cancellation pulsations in response to compression by the input piston of hydraulic fluid in the hydraulic fluid line. The stack of piezoelectric actuators is configured to actuate the input piston.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is an example plot of fuel pressure pulsations in a fuel rail of a direct injection (DI) engine having a camshaft-driven fuel pump according to the prior art;

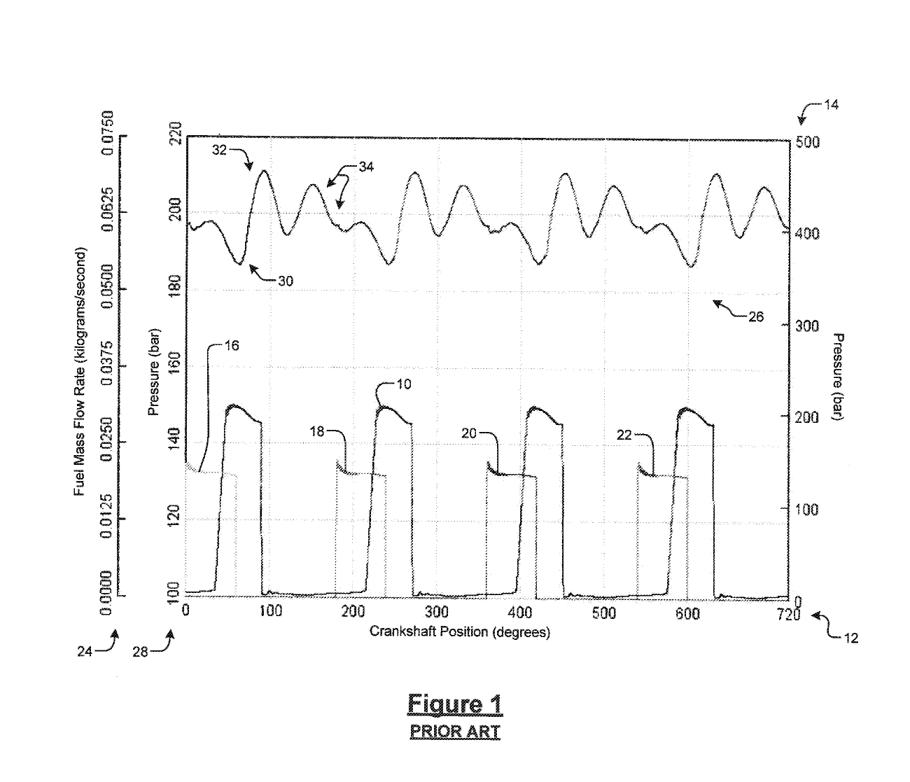

FIG. 2 is an example partial schematic diagram of an engine system according to the principles of the present disclosure;

FIG. 3A is an example partial schematic diagram of a fuel system according to the principles of the present disclosure;

FIG. 3B is another example partial schematic diagram of a fuel system according to the principles of the present disclosure;

FIG. 4 is an example functional block diagram of a controller according to the principles of the present disclosure; and

FIG. 5 is a flow diagram of an example method of active engine fuel pressure pulsation cancellation according to the principles of the present disclosure.

### DESCRIPTION

As explained above, while conventional engine fuel systems work for their intended purpose, there remains a need for improvement in the relevant art. Accordingly, active engine fuel pressure pulsation cancellation techniques are presented. While the systems and methods discussed herein are particularly useful for direct injection (DI) engines having camshaft-driven fuel pumps, the techniques are also applicable to port fuel injection (PFI) engines having camshaft-driven fuel pumps and diesel engines having common fuel rails and camshaft-driven fuel pumps. An actuator is configured to generate liquid-borne cancellation pulsations in a fuel rail in response to a cancellation signal. The term “liquid-borne” as used herein refers to pulsations within a fluid medium, e.g., a fuel. In one exemplary implementation, the actuator is a piezoelectric actuator.

In accordance with an aspect of the present disclosure, a controller receives a fuel pressure signal having fuel pressure pulsations from a fuel pressure sensor associated with the fuel rail. The controller detects the pressure pulsations and generates the cancellation signal based on an opposite polarity of the fuel pressure pulsations. The controller then provides the cancellation signal to the actuator, which generates the liquid-borne cancellation pulsations thereby canceling the fuel pressure pulsations in the fuel rail. By canceling the fuel pressure pulsations, the engine experiences at least one of decreased emissions and decreased noise/vibration/harshness (NVH). In some cases, canceling the fuel pressure pulsations also decreases warranty costs by extending a life of fuel lines in the engine fuel system.

It will be appreciated that the techniques of the present disclosure could also be applied to other high pressure fluid systems. Examples of high pressure fluid systems include hydraulic circuits in automatic transmissions, anti-lock brake system (ABS) circuits, and power steering systems, such as power steering systems having piston pumps. Fluid pressure pulsations in these systems could have similar negative effects on system performance, as well as potentially causing component damage if unaccounted for. It will also be appreciated that other types and/or configurations of the actuator(s) could be implemented, as well as other techniques for generating/using the cancellation signal to control the actuator(s).

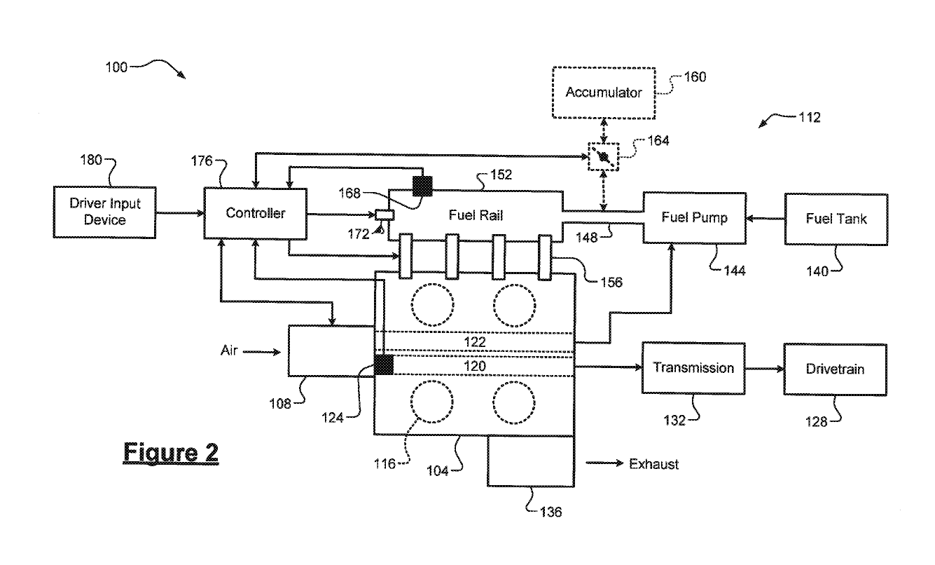

Referring now to FIG. 2, an example functional block diagram of an example engine system 100 is illustrated. The exemplary engine system 100 includes an engine 104 that receives air via an induction system 108 and combines the air with fuel from a fuel system 112 to create a mixture of air and fuel. Examples of the fuel include gasoline and diesel fuel. The mixture of air and fuel is compressed by pistons (not shown) within cylinders 116 and combusted within combustion chambers, e.g., by spark plugs, to drive the pistons, which rotatably turn a crankshaft 120 to generate drive torque. While four cylinders 116 are shown, it will be appreciated that the engine 104 could include other numbers of cylinders 116. The crankshaft 120 is also operable to drive a camshaft 122 of the engine 104. The camshaft 122 is operable to control intake/exhaust valves (not shown) of the engine 104. It will be appreciated that more than one camshaft 122 could be implemented.

A crankshaft position sensor 124 measures a rotational position of the crankshaft 120. The drive torque is transferred to a drivetrain 128 via a transmission 132. Exhaust gas resulting from combustion is expelled from the cylinders and treated by an exhaust system 136 before being released into the atmosphere. The fuel system 112 includes a fuel tank 140, a fuel pump 144, a fuel line 148, a fuel rail 152, and fuel injectors 156. The fuel system 112 optionally includes an accumulator 160 and an accumulator valve 164. The fuel pump 144 is driven by the camshaft 122 and therefore is also referred to as a camshaft-driven fuel pump 144. In one exemplary implementation, the fuel pump 144 is a DI camshaft-driven plunger pump.

The fuel pump 144 pumps fuel from the fuel tank 140 into the fuel rail 152 via the fuel line 148. The fuel rail 152 houses the fuel, which could be highly pressurized, e.g., in DI engines. Optionally, the accumulator valve 164 is configured to be partially or fully opened to allow high pressure fuel from the fuel pump 144 flowing through the fuel line 148 to flow into the accumulator 160. In other words, the fuel from the fuel line 148 is able to be diverted into the accumulator 160 when the accumulator valve 164 is open because this path represents a path of lesser resistance than a path to the fuel rail 152. For example only, the accumulator valve 164 could be opened at engine idle or deceleration fuel cutoff (DFCO) events.

It will be appreciated that the fuel system 112 could include other suitable components that are not illustrated for clarity, such as a lift fuel pump in the fuel tank 140, a pump module relief valve for the lift fuel pump/fuel tank 140, a pump spill solenoid valve arranged between the fuel tank 140 and the fuel pump 144, and a pump outlet check valve arranged between the fuel pump 144 and the fuel rail 152, e.g., at a point before the accumulator valve 164.

The fuel injectors 156 inject the fuel from the fuel rail 152 into the engine 104. Examples of the configuration of the fuel injectors 156 include injecting the fuel directly into combustion chambers of the cylinders 116 (DI) and injecting the fuel into intake ports of the cylinders 116 (PFI). In one exemplary implementation, the fuel injectors 156 comprise four fuel injectors, e.g., one fuel injector 156 per cylinder 116. It will be appreciated, however, that other numbers of fuel injectors 156 could be implemented. When the fuel in the fuel rail 152 is highly pressurized, such as in a DI system, the fuel injectors 156 are able to quickly and easily inject the fuel into the engine 104 in a short open timing or pulse-width.

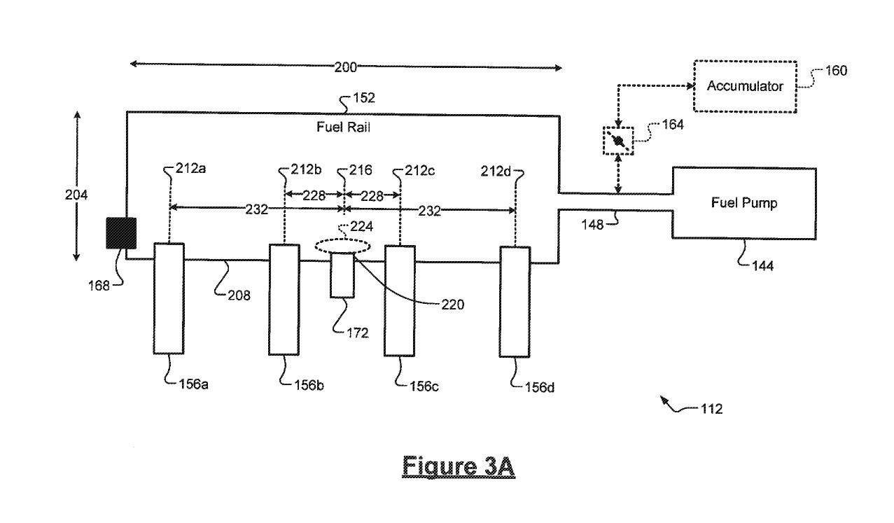

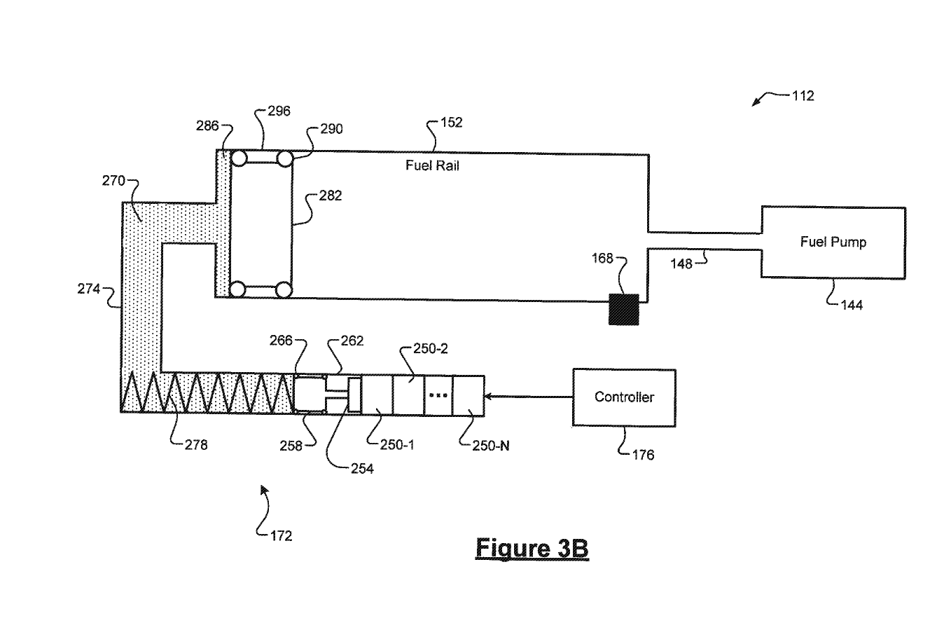

A fuel pressure sensor 168 generates a fuel pressure signal based on a measured pressure of the fuel in the fuel rail 152. In one exemplary implementation, the fuel pressure sensor 168 is a high-frequency fuel pressure sensor for more accurately capturing fuel pressure pulsations in the fuel rail 152. In other words, conventional engine fuel systems that filter (average/smooth) the fuel pressure signal typically implement a lower frequency fuel pressure sensor. An optional actuator 172 (or actuator system 172; see FIG. 3B) is associated with the fuel rail 152 and is configured to generate liquid-borne cancellation pulsations in the fuel rail 152 in response to a cancellation signal. Examples of the optional actuator 172 include a piezoelectric actuator and an electromagnetic actuator. Various configurations of and specific operation of the actuator 172 are shown in FIGS. 3A-3B and discussed in greater detail below.

A controller 176 controls operation of the engine system 100. The controller 176 can control airflow into the engine 104 and/or timing/pulse-widths of fuel injection by the fuel injectors 156, e.g., using pulse-width modulated (PWM) control signals, such that the engine 104 generates a desired drive torque in response to an engine torque request from a driver input device 180, e.g., an accelerator pedal. The controller 176 is also configured to control the actuator 172 and/or the accumulator valve 164 to implement the active engine fuel pressure pulsation cancellation techniques of the present disclosure, which are described in greater detail below.

Referring now to FIG. 3A, an example partial schematic diagram of the fuel system 112 is illustrated. The fuel rail 152 defines a length 200 and a height 204. It will be appreciated that the fuel rail 152 also defines a depth (not shown), and that the length 200, the height 204, and the depth collectively define a volume of the fuel rail 152. Fuel injectors 156a, 156b, 156c, and 156d (collectively “fuel injectors 156”) are arranged at a bottom 208 of the fuel rail 152 and at equidistance locations 212a, 212b, 212c, and 212d along the length 200 of the fuel rail 152. As shown, the actuator 172 is arranged at a center/mid-point 216 along the length 200 of the fuel rail 152.

In conventional noise cancellation systems, the actuator 172 would be arranged as close as possible to a microphone, i.e., the fuel pressure sensor 168. As shown, however, the actuator 172 is not arranged near the fuel pressure sensor 168 and instead is arranged as close as possible to the fuel injectors 156. By arranging the actuator 172 as close as possible to the fuel injectors 156, the actuator 172 is able to more effectively cancel fuel pressure pulsations such that they do not affect fuel injection. In one exemplary implementation, the actuator 172 is an electromagnetic (EM) actuator. In another exemplary implementation, the engine system 100 includes a plurality of actuators 172, such as one actuator 172 per fuel injector 156 and located as close to each fuel injector 156 as possible.

In the illustrated exemplary implementation, the actuator 172 is a piezoelectric actuator having at least a portion 220 disposed within the fuel rail 152. The controller 176 provides a current waveform to the piezoelectric actuator, which in turn vibrates in response to the current waveform. Piezoelectric actuators are very effective at creating these liquid-borne cancellation pulsations while consuming minimal power. The actuator 172 optionally includes a diaphragm 224 attached to the portion 220 disposed within the fuel rail 152. It will be appreciated, however, that only the diaphragm 224 and not the actuator 172 (or a portion of the actuator 172) could be disposed within the fuel rail 152. In response to actuation (vibration) of the actuator 172, the diaphragm 224 generates larger pressure pulsations by displacing fuel in the fuel rail 152, e.g., similar to a cone of a speaker. In sum, the diaphragm 224 provides for more effective fuel pressure pulsation cancellation by a piezoelectric actuator in a fluid medium, i.e., liquid-borne or in the fuel.

The actuator 172 is controlled by the controller 176. More particularly, the controller 176 generates a cancellation signal and provides the cancellation signal to the actuator 172. In one exemplary implementation, the cancellation signal is a liquid-borne cancellation signal. The cancellation signal is based on an opposite polarity of the fuel pressure pulsations derived from the unfiltered fuel pressure signal from the fuel pressure sensor 168. In one exemplary implementation, the cancellation signal has the opposite polarity of the fuel pressure pulsations. Generating the cancellation signal could include specifying its shape, its amplitude, and/or its timing, e.g., its period. As shown, the fuel pressure sensor 168 is located at an end of the fuel rail 152 and towards the bottom 208 of the fuel rail 152. It will be appreciated, however, that the fuel pressure sensor 168 could be arranged at any suitable location for accurately and efficiently measuring the pressure of the fuel in the fuel rail 152.

Depending on which of the cylinders 116 is a next firing cylinder, the cancellation signal could be phase-shifted to account for a position of one of the fuel injectors 156 corresponding to the next firing cylinder with respect to a position of the actuator 172. The next firing cylinder is determined based on a rotational position of the crankshaft 120. In other words, each of the cylinders 116 corresponds to a specific position or range of positions of the crankshaft 120. In one exemplary implementation, the engine 104 includes four cylinders 116 and each cylinder is associated with every 90 degrees of the crankshaft 120 (0/360, 90, 180, 270). For example, a rotational position of 45 degrees would indicate that the next firing cylinder is the cylinder associated with 90 degrees. The rotational position of the crankshaft 120 is measured by the crankshaft position sensor 124.

As shown, the actuator 172 is located at the center 216 along the length 200 of the fuel rail 152. Fuel injectors 156b and 156c are spaced from the actuator 172 by a distance 228. Fuel injectors 156a and 156d are spaced apart from the actuator 172 by a distance 232 that is greater than distance 228. Thus, the controller 176 could phase-shift the cancellation signal more when the next firing cylinder is associated with fuel injectors 156a or 156d compared to a phase-shift when the next firing cylinder is associated with fuel injectors 156b or 156c. This phase-shift could be further based on other parameters such as the topology of the fuel rail 152 (length 200, height 204, and depth), pressure pulsation arrival time, a known speed of sound in the fuel, and the like.

Instead of the actuator 172, the fuel pressure pulsations in the fuel rail 152 could also be cancelled by controlling the accumulator valve 164. More specifically, based on the fuel pressure pulsations derived from the unfiltered fuel pressure signal, the controller 176 controls the accumulator valve 164 to generate liquid-borne cancellation pulsations that cancel the fuel pressure pulsations in the fuel rail 152. This could include the controller 176 generating and using a cancellation signal for the accumulator valve 164 similar to the cancellation signal for the actuator 172. It will be appreciated, however, that the cancellation signal for the accumulator valve 164 could be different than the cancellation signal for the actuator 172 because actuating the accumulator valve 164 provides a different fluid response than actuating the actuator 172.

Referring now to FIG. 3B, another exemplary implementation of the actuator 172 (or actuator system 172) is illustrated. While not shown in FIG. 3B, it will be appreciated that the fuel system 112 could have the same or similar configuration as shown in FIG. 3k In one exemplary implementation, the actuator 172 comprises piezoelectric actuators 250-1, 250-2 . . . 250-N (collectively “piezoelectric actuators 250,” N≧2). The piezoelectric actuators 250 are arranged in a line or a stack next to one another, and thus are also referred to as a stack of piezoelectric actuators 250. The stack of piezoelectric actuators 250 are actuated by the controller 176, such as in response to a supplied current. The stack of piezoelectric actuators 250 are coupled to an actuator member 254 that actuates an input piston 258. In one exemplary implementation, the stack of piezoelectric actuators 250, the actuator member 254, and the input piston 258 are all located within a housing 262. In one exemplary implementation, one or more input piston seals 266 are arranged between edges of the input piston 258 and the housing 262. For example only, there could be four input piston seals 266.

When actuated by the actuator member 254, the input piston 258 compresses a hydraulic fluid 270 in a hydraulic fluid line 274. In one exemplary implementation, the hydraulic fluid is oil. When not actuated or no longer actuated by the actuator member 254, the input piston 258 returns to an initial position via a spring 278 arranged in the hydraulic fluid line 274. The compression of the hydraulic fluid 270 in the hydraulic fluid line 274 actuates an output piston 282 disposed within the fuel rail 152. Actuation of the output piston 282 generates cancellation pulsations by displacing a larger amount of fuel in the fuel rail 152. In one exemplary implementation, the fuel rail 152 could be modified for this implementation. For example, the fuel rail 152 could be extended to house the output piston 282 as well as a portion 286 of the hydraulic fluid 270 from the hydraulic fluid line 274. In one exemplary implementation, one or more output piston seals 292 are arranged between edges of the output piston and an inner wall 296 of the fuel rail 152. For example only, there could be four output piston seals 292.

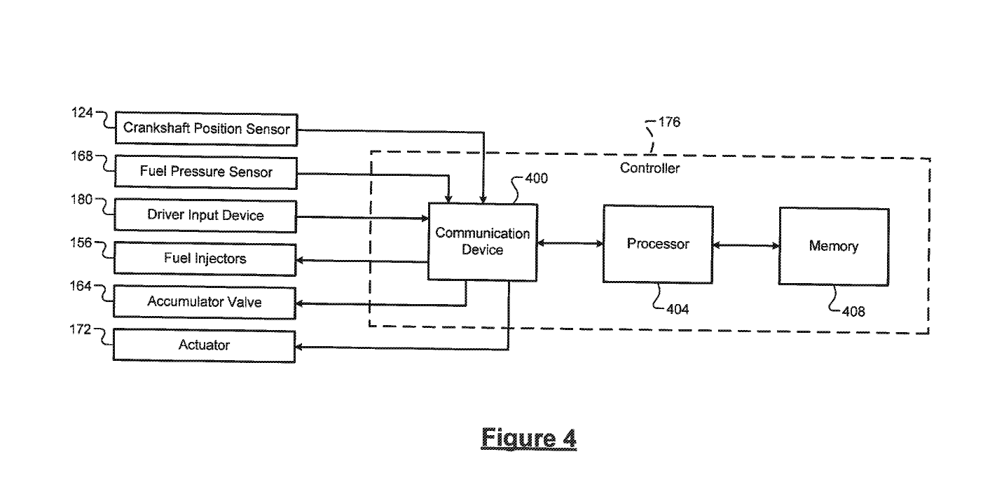

Referring now to FIG. 4, an example functional block diagram of the controller 176 is illustrated. The controller 176 includes a communication device 400, a processor 404, and a memory 408. The communication device 400 is configured to communicate with components of the engine system 100 via a controller area network. Examples of these components include, but are not limited to, the induction system 108, the crankshaft position sensor 124, the fuel injectors 156, the accumulator valve 164, the fuel pressure sensor 168, the actuator 172, and the driver input device 180. The memory 408 is any suitable storage medium configured to store information at the controller 176.

The processor 404 controls operation of the controller 176. Example functions performed by the processor 404 include loading/executing an operating system of the controller 176, controlling transmission and processing information received by the communication device 400 via the controller area network, and controlling read/write operations at the memory 408. In one exemplary implementation, the processor 404 is also configured to perform the active engine fuel pressure pulsation cancellation techniques of the present disclosure described above and as described in additional detail below.

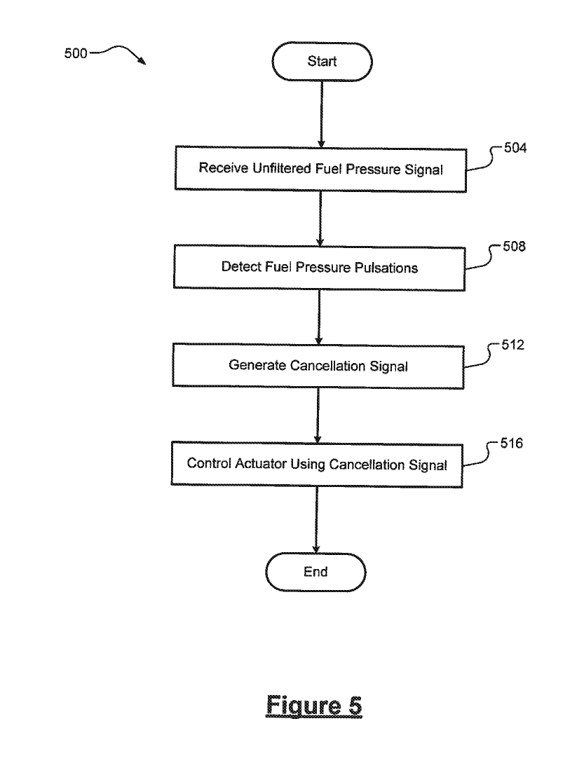

Referring now to FIG. 5, an example flow diagram of a method 500 of active engine fuel pressure pulsation cancellation is illustrated. At 504, the controller 176 receives the unfiltered fuel pressure signal indicative of the measured pressure of fuel in the 152. At 508, the controller 176 detects fuel pressure pulsations in the fuel rail 152 based on the unfiltered fuel pressure signal. At 512, the controller 176 generates the cancellation signal based on an opposite polarity of the fuel pressure pulsations. In one exemplary implementation, the unfiltered fuel rail pressure signal corresponds to a currently firing or previously fired one of the cylinders 116 of the engine 104, and the cancellation signal is further based on a fuel injection timing or pulse-width for a next firing one of the cylinders 116 of the engine 104.

At 516, the controller 176 controls an actuator associated with the fuel rail 152 utilizing the cancellation signal, wherein the cancellation signal causes the actuator to generate liquid-borne cancellation pulsations that cancel the fuel pressure pulsations in the fuel rail 152. In one exemplary implementation, the actuator is actuator 172. In another exemplary implementation, the actuator is the accumulator valve 164. In one exemplary implementation, controlling the actuator further comprises the controller 176 phase-shifting the cancellation signal based on a distance between (i) the actuator and (ii) one of the fuel injectors 156 corresponding to the next firing one of the cylinders 116 of the engine 104. The method 500 then ends or returns to 504 for one or more additional cycles.

It should be understood that the mixing and matching of features, elements, methodologies and/or functions between various examples could be expressly contemplated herein so that one skilled in the art would appreciate from the present teachings that features, elements and/or functions of one example could be incorporated into another example as appropriate, unless described otherwise above.

What is claimed is:

1. An engine system, comprising;
an engine configured to rotatably turn a crankshaft to generate drive torque, the crankshaft also being operable to drive a camshaft of the engine;
a fuel system comprising:
a fuel rail configured to house a fuel,
a fuel pump driven by the camshaft and configured to pump the fuel into the fuel rail, and
fuel injectors configured to inject the fuel from the fuel rail into the engine;
a fuel pressure sensor configured to generate an unfiltered fuel pressure signal indicative of a measured pressure of the fuel in the fuel rail;
an actuator configured to generate liquid-borne cancellation pulsations in the fuel rail in response to a cancellation signal; and
a controller configured to:
receive the unfiltered fuel pressure signal,
detect fuel pressure pulsations in the fuel rail based on the unfiltered fuel pressure signal,
generate the cancellation signal based on an opposite polarity of the fuel pressure pulsations, and
control the actuator utilizing the cancellation signal to generate the liquid-borne cancellation pulsations to cancel the fuel pressure pulsations in the fuel rail.

2. The engine system of claim 1, wherein the unfiltered fuel rail pressure signal corresponds to a currently firing or previously fired cylinder of the engine, and wherein the cancellation signal is further based on a fuel injection timing or pulse-width for a next firing cylinder of the engine.

3. The engine system of claim 2, wherein the controller is further configured to phase-shift the cancellation signal based on a distance between (i) the actuator and (ii) one of the fuel injectors corresponding to the next firing cylinder of the engine.

4. The engine system of claim 3, wherein the controller is further configured to:
receive a crankshaft position signal indicative of a rotational position of the crankshaft; and
determine the next firing cylinder of the engine based on the crankshaft position signal.

5. The engine system of claim 1, wherein the actuator is a piezoelectric actuator having at least a portion disposed within the fuel in the fuel rail proximate the fuel injectors.

6. The engine system of claim 1, wherein the actuator is a piezoelectric actuator attached to a diaphragm disposed within the fuel in the fuel rail.

7. The engine system of claim 1, further comprising:
a fuel line between the fuel pump to the fuel rail; and
an accumulator housing fuel diverted from the fuel line;
wherein the actuator is an accumulator valve configured to divert the fuel from the fuel line into the accumulator.

8. The engine system of claim 1, wherein the actuator comprises:
a stack of piezoelectric actuators;
an input piston;
a hydraulic fluid line; and
an output piston disposed within the fuel rail;
wherein the output piston is configured to generate the liquid-borne cancellation pulsations in response to compression by the input piston of hydraulic fluid in the hydraulic fluid line, and wherein the stack of piezoelectric actuators are configured to actuate the input piston in response to the cancellation signal.

9. The engine system of claim 1, wherein the engine is a direct injection (DI) engine.

10. The engine system of claim 1, wherein the engine is a port fuel injection (PFI) engine or a diesel engine having a common fuel rail.

11. A method, comprising:
receiving, at a controller of an engine, the controller having one or more processors, an unfiltered fuel pressure signal indicative of a measured pressure of a fuel in a fuel rail of the engine, wherein the engine is configured to rotatably turn a crankshaft to generate drive torque, wherein the crankshaft is also operable to drive a camshaft of the engine, wherein the camshaft drives a fuel pump configured to pump the fuel into the fuel rail, and wherein fuel injectors are configured to inject the fuel from the fuel rail into the engine;
detecting, at the controller, fuel pressure pulsations in the fuel rail based on the unfiltered fuel pressure signal;
generating, at the controller, a cancellation signal based on an opposite polarity of the fuel pressure pulsations; and
controlling, by the controller, utilizing the cancellation signal, an actuator associated with the fuel rail, wherein the cancellation signal causes the actuator to generate liquid-borne cancellation pulsations that cancel the fuel pressure pulsations in the fuel rail.

12. The method of claim 11, wherein the unfiltered fuel rail pressure signal corresponds to a currently firing or previously fired cylinder of the engine, and wherein the cancellation signal is further based on a fuel injection timing or pulse-width for a next firing cylinder of the engine.

13. The method of claim 12, further comprising phase-shifting, at the controller, the cancellation signal based on a distance between (i) the actuator and (ii) one of the fuel injectors corresponding to the next firing cylinder of the engine.

14. The method of claim 13, further comprising:
receiving, at the controller, a crankshaft position signal indicative of a rotational position of the crankshaft; and
determining, at the controller, the next firing cylinder of the engine based on the crankshaft position signal.

15. The method of claim 11, wherein the actuator is a piezoelectric actuator having at least a portion disposed within the fuel in the fuel rail proximate the fuel injectors.

16. The method of claim 11, wherein the actuator is a piezoelectric actuator attached to a diaphragm disposed within the fuel in the fuel rail.

17. The method of claim 11, wherein the actuator is an accumulator valve configured to divert a flow of the fuel from a fuel line into an accumulator, wherein the fuel line houses the fuel flowing from the fuel pump to the fuel rail.

18. The method of claim 11, wherein the actuator comprises:
a stack of piezoelectric actuators;
an input piston;
a hydraulic fluid line; and
an output piston disposed within the fuel rail,
wherein the output piston is configured to generate the liquid-borne cancellation pulsations in response to compression by the input piston of hydraulic fluid in the hydraulic fluid line, and wherein the stack of piezoelectric actuators is configured to actuate the input piston in response to the cancellation signal.

19. The method of claim 11, wherein the engine is a direct injection (DI) engine.
